(19) United States
(12) Patent Application Publication
(10) Pub. No.: US 2007/0168582 A1
(43) Pub. Date: Jul. 19, 2007

(54) METHOD FOR PROTECTING AN I/O PORT OF A COMPUTER

(76) Inventors: Chao-Chen Huang, Shenzhen (CN); Yu-Hsu Lin, Shenzhen (CN); Yi-Ching Weng, Shenzhen (CN); Zheng-Quan Peng, Shenzhen (CN)

Correspondence Address: NORTH AMERICA INTELLECTUAL PROPERTY CORPORATION, P.O. BOX 506, MERRIFIELD, VA, 22116, US

(21) Appl. No.: 11/308,589

(22) Filed: Apr. 10, 2006

(30) Foreign Application Priority Data
Sep. 7, 2005 (CN) 200510037113.X

(51) Int. Cl. G06F 3/00; G06F 5/00

(52) U.S. Cl. 710/36

(57) ABSTRACT

The present invention provides a method for protecting an input/output port of a computer. The method includes the steps of: searching for the entry representing the input/output port in the system's registry editor (REGEDIT) of the computer according to a corresponding global unique identifier of the input/output port; obtaining a component identifier of the input/output port from the entry; searching for the physical input/output port having the obtained component identifier in the hardware library of the computer; defining a parameter for controlling the authorization of accessing the physical input/output port, the parameter having an ENABLE value and a DISABLE value corresponding to an accessible status and an inaccessible status of the physical input/output port respectively; and setting a password for controlling the authorization of changing the value of the parameter.

### FIELD OF THE INVENTION

The present invention is generally related to methods for securing a computer, and more particularly, to a method for protecting input/output ports of a computer.

### DESCRIPTION OF RELATED ART

The development and improvement of computers and peripheral components thereof gets faster and faster day by day. Services offered by the Internet have made computer usage adapted in people's every day life. People often uses the Internet to exchange data and information bringing communication conveniences between people. However, besides these conveniences, computers, along with the Internet, brings security risks to our personal computer and networks.

One such problems is the risk of sharing hardware resource on computers over the Internet, especially when sharing input/output ports (I/O ports) that can be used to perform writing or reading operations on computers. Such I/O ports may be universal serial bus (USB) ports, card reader ports, optical disk driver ports, floppy disk driver ports, network interface cards, and so on. Via these I/O ports, one can transfer, modify or deleted data in a PC's data storage device. Suppose the data is vital and confidential and there is no secure apparatus or system implemented on the computer, what would happen?

One approach to solve the above problem is by using a password to control the authorization of using the computer. For example, when an authorized user leaves the computer idle over a certain period of time, the operating system of the computer would “lock” the computer by a password control until the correct password is received.

However, a new problem arises. If the certain period of idle time is set too short, it obviously brings inconvenience for the authorized user. Yet, if the certain time is set too long, a “hacker” would have enough time to steal data or destroy data in the computer via the I/O ports.

What is needed, therefore, is a method that can protect I/O ports of a computer more efficiently and securely.

### SUMMARY OF INVENTION

One embodiment provides a method for protecting an input/output port of a computer. The method includes the steps of: searching for the entry representing the input/output port in the system's registry editor (REGEDIT) of the computer according to a corresponding global unique identifier of the input/output port; obtaining a component identifier of the input/output port from the entry; searching for the physical input/output port having the obtained component identifier in a hardware library of the computer; defining a parameter for controlling the authorization of accessing the physical input/output port, the parameter having an ENABLE value and a DISABLE value respectively corresponding to an accessible status and an inaccessible status of the physical input/output port; and setting a password for controlling the authorization of changing the value of the parameter.

Other systems, methods, features, and advantages of the present invention will be or become apparent to one skilled in the art upon examination of the following drawings and detailed description.

### BRIEF DESCRIPTION OF THE DRAWINGS

FIG. 1 is a flowchart of a preferred method for protecting an input/output port in accordance with one preferred embodiment; and

FIG. 2 is a flowchart of a method for protecting a network interface card in accordance with one preferred embodiment.

### DETAILED DESCRIPTION

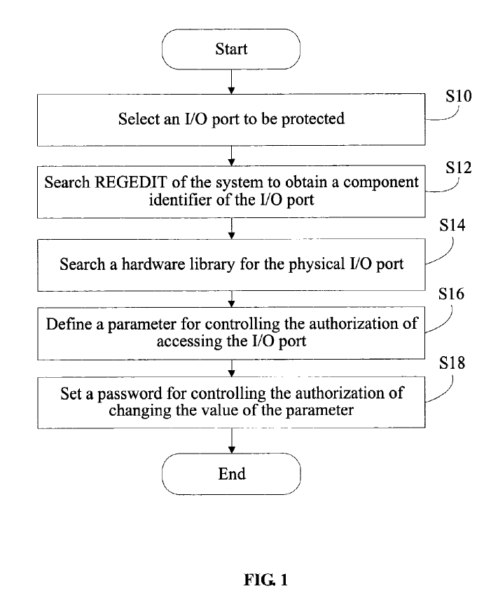

FIG. 1 is a flowchart of a preferred method for protecting an input/output port in accordance with one preferred embodiment. The method may be implemented by a personal computer, such as an IBM personal computer, a Macintosh, or any other computing device that can process and compute data, such as a server or a personal digital assistant (PDA). The computer typically includes various hardware devices/components, software applications, and an operating system (OS) (such as the Windows OS) that manages the hardware devices/components and software applications. Among the various hardware devices/components, the computer has various input/output (I/O) ports. Such I/O ports may be universal serial bus (USB) ports, card reader ports, optical disk driver ports, floppy disk driver ports, network interface cards, and so on. Via these I/O ports, one can transfer, modify or delete data in the computer's data storage device. The computer is installed with particular software for implementing the preferred method so that these I/O ports can be protected securely.

In step S10, a user selects an I/O port to be protected by executing the particular software. Once the I/O port is selected, the particular software shows a global unique identifier (GUID) corresponding to the I/O port to the user. The particular software has mappings for each I/O port and its corresponding GUID.

A GUID is typically a unique 128-bit number that is produced by the Windows OS or by some Windows applications to identify a particular component/device, an application, a file, a database entry, and/or a user.

In step S12, the computer searches for an entry corresponding to the I/O port in the system's registry editor (REGEDIT) of the computer according to its GUID, and obtains a component identifier of the I/O port from the entry. The component identifier is a field in the entry of the system REGEDIT. The system REGEDIT is an advanced tool that enables a user to change settings in the system registry of a computer, which contains information about how the computer runs.

In step S14, the computer searches for a physical I/O port having the obtained component identifier in a hardware library of the computer. In step S16, the computer defines a parameter for controlling the authorization of accessing the physical I/O port. The parameter may have a value “ENABLE” and the other value “DISABLE,” that corresponds to either an accessible status or an inaccessible status of the physical I/O port respectively. In step S18, the user sets a password for controlling the authorization of changing the value of the parameter.

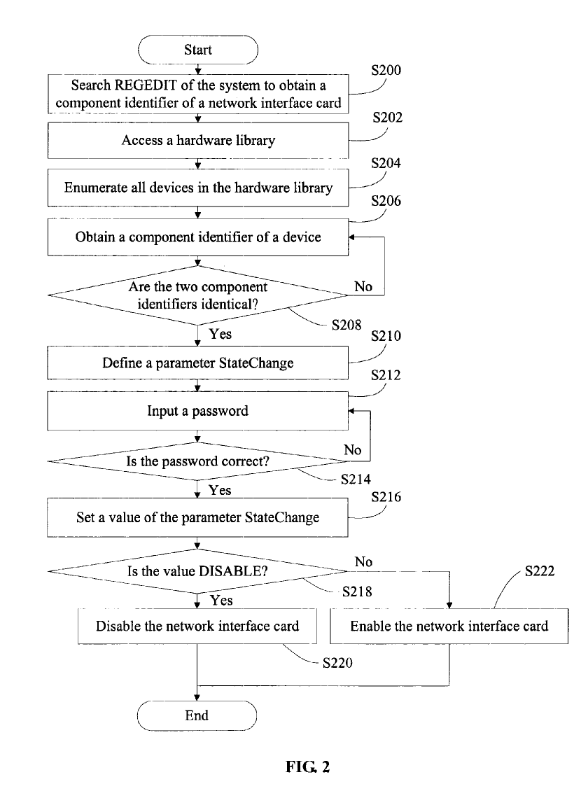

In order to better illustrate the preferred method, herein below is a detailed instance of a method for protecting a network interface card of a computer in combination with FIG. 2. It should be noted that once a user selects the network interface card, a corresponding GUID is obtained by the computer.

In step S200, the computer searches in the system REGEDIT to obtain a component identifier of the network interface card. In the Windows OS, the path of the entry of a network interface card is HKEY_LOCAL_MACHINE\SYSTEM\CurrentControlSet\Control\Class{4D36E972-E325-11CE-BFC1-08002BE10318}\0000. According to the field ComponentId of the entry, the component identifier of the network interface card is shown pci\ven_{—}8086&amp;dev_{—}1229&amp;subsys_b1340e11.

In step S202, the computer invokes a function SetupDiGetclassDevs in the drivers developing kit (DDK) to access the hardware library of the computer. It should be noted that the DDK functions mentioned herein above and below can be replaced by other functions that are programmed to achieve the same function in the preferred method. In step S204, the computer invokes a DDK function SetupDiEnumDeviceInfo to enumerate all devices/components in the hardware library. In step S206, the computer invokes a DDK function SetupDiGetDeviceRegistryProperty to obtain a component identifier of a device/component in the hardware library. In step S208, the computer compares the two component identifiers to determine whether they are identical.

If the two component identifiers are not identical, the procedure returns to step S206 to obtain a component identifier of a next device/component in the hardware library. Otherwise, if the two component identifiers are identical, that is, the physical network interface card is found, then in step S210, the computer defines a SP_PROPCHANGE_PARAMS type of parameter StateChange. In step S212, the user sets a password for controlling the authorization of changing the value of the parameter when the computer implements the method for the first time. Otherwise, when a password is received in future usage, in step S214, the computer determines whether the received password is the same password set by the user

If the received password is wrong, the computer waits for receiving another password. Otherwise, if the inputted password is correct, in step S216, the user sets a value for the parameter. The value may be “ENABLE” or “DISABLE,” respectively corresponding to an accessible status or an inaccessible status of the physical network interface card.

In step S218, the computer checks the value of the parameter. If the value is “DISABLE,” in step S220, the computer disables the network interface card by invoking a function SetupDiSetClassInstallParams. Otherwise, if the value is “ENABLE,” in step S222, the computer enables the network interface card also by invoking the function SetupDiSetClassInstallParams.

It should be emphasized that the above-described embodiments of the present invention, particularly, any “preferred” embodiments, are merely possible examples of implementations, merely set forth for a clear understanding of the principles of the invention. Many variations and modifications may be made to the above-described embodiment(s) of the invention without departing substantially from the spirit and principles of the invention. All such modifications and variations are intended to be included herein within the scope of this disclosure and the present invention and protected by the following claims.

What is claimed is:

1. A method for protecting an input/output port of a computer, the method comprising the steps of:
searching for an entry corresponding to the input/output port in the system's registry editor of the computer according to a corresponding global unique identifier of the input/output port;
obtaining a component identifier of the input/output port from the entry;
searching for the physical input/output port having the obtained component identifier in a hardware library of the computer;
defining a parameter for controlling the authorization of accessing the physical input/output port, the parameter having an ENABLE value and a DISABLE value corresponding to an accessible status and an inaccessible status of the physical input/output port respectively; and
setting a password for controlling the authorization of changing the value of the parameter.

2. The method according to claim 1, wherein the step of searching for the physical input/output port having the obtained component identifier in the hardware library of the computer comprises the steps of:
accessing the hardware library of the computer;
capturing component identifiers of hardware devices in the hardware library; and
determining whether the component identifier of any hardware device is identical with the one obtained from the entry.

3. The method according to claim 1, further comprising a step of invoking an enabling function to enable the physical input/output port so that the physical input/output port is accessible if the value of the parameter is set as the ENABLE value.

4. The method according to claim 3, wherein the step of searching for the physical input/output port having the obtained component identifier in the hardware library of the computer comprises the steps of:
accessing the hardware library of the computer;
capturing component identifiers of hardware devices in the hardware library; and
determining whether the component identifier of any hardware device is identical with the one obtained from the entry.

5. The method according to claim 1, further comprising a step of invoking a disabling function to disable the physical input/output port so that the physical input/output port is inaccessible if the value of the parameter is set as the DISABLE value.

6. The method according to claim 5, wherein the step of searching for the physical input/output port having the obtained component identifier in the hardware library of the computer comprises the steps of:
accessing the hardware library of the computer;
capturing component identifiers of hardware devices in the hardware library; and
determining whether the component identifier of any hardware device is identical with the one obtained from the entry.

7. The method according to claim 1, wherein the input/out port is a universal serial bus port.

8. The method according to claim 1, wherein the input/out port is a card reader port.

9. The method according to claim 1, wherein the input/out port is an optical disk driver port.

10. The method according to claim 1, wherein the input/out port is a floppy disk driver port.

11. The method according to claim 1, wherein the input/out port is a network interface card.
